(19) United States
(12) Patent Application Publication
(10) Pub. No.: US 2010/0171692 A1
(43) Pub. Date: Jul. 8, 2010

(54) Input device and display device

(75) Inventors: Wook Chang, Seoul (KR); Joon Ah Park, Seoul (KR); Hyun Jeong Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS, CO., LTD., Suwon-si (KR)

(21) Appl. No.: 12/457,900

(22) Filed: Jun. 24, 2009

(30) Foreign Application Priority Data
Jan. 7, 2009 (KR) 10-2009-0001003

(51) Int. Cl. G09G 5/00

(52) U.S. Cl. 345/156

(57) ABSTRACT

An input device and a display device are provided. The input device may receive object information, associated with an object displayed on a display device, from the display device, sense at least one motion of a user, analyze the at least one sensed motion of the user based on the object information, and transmit the analysis result of the analysis unit to the display device, and the display device may receive the analysis result and control the object based on the analysis result.

### CROSS-REFERENCE TO RELATED APPLICATIONS

This application claims the priority benefit of Korean Patent Application No. 10-2009-0001003, filed on Jan. 7, 2009, in the Korean Intellectual Property Office, the disclosure of which is incorporated herein by reference.

### BACKGROUND

1. Field

Exemplary embodiments relate to an input device and a display device, and more particularly, to an input device and a display device which sense a motion of a user, and thereby may provide a user with an initiative input interface.

2. Description of the Related Art

Currently, the release of various types of information devices increases users' interests regarding various types of input devices that may control the information devices.

Generally, a mouse, a keyboard, and the like are being used in a computer and the like as an input device.

The input device such as the mouse may provide an input interface based on a Graphical User Interface (GUI) and thus may be readily used among many users using an information device such as the computer.

However, existing input devices may be generally appropriate for a command line interface or a two-dimensional (2D) GUI. Therefore, a user that is unfamiliar with a latest information device, for example, a child, an elderly and frail person, and the like, may have difficulties in using the input devices.

In particular, as a three-dimensional (3D) game or 3D Internet is being currently generalized, there is an increasing need for an input device that may control an object that is displayed on a virtual 3D space.

However, since the existing input devices are manufactured based on the 2D input interface, they may be inappropriate for controlling the object in the virtual 3D space.

Accordingly, there is a need for a research regarding an input device that may provide a user with a convenient interface in a virtual 3D space.

### SUMMARY

Exemplary embodiments may provide an input device and a display device which may analyze a motion of a user based on object information associated with an object displayed on the display device, may control a motion of the object, and thereby may provide a user with an intuitive input interface.

According to exemplary embodiments, there may be provided an input device, including: a receiving unit to receive object information from a display device, the object information being associated with an object displayed on the display device; a motion sensing unit to sense at least one motion of a user; an analysis unit to analyze the at least one sensed motion of a user based on the object information; and a transmission unit to transmit an analysis result of the analysis unit to the display device, wherein the display device receives the analysis result and controls the object based on the analysis result.

According to exemplary embodiments, there may be provided a display device, including: a display unit to display an object; a motion sensing unit to at least one motion of a user through an input device; an analysis unit to analyze the at least one sensed motion of the user based on object information associated with the object; and a control unit to control the object based on an analysis result of the analysis unit.

According to other exemplary embodiments, there may be provided an input device, including: a receiving unit to receive object information from a display device, the object information being associated with an object displayed on the display device; a display unit to analyze the object information and display the object; a motion sensing unit to sense at least one motion of a user; an analysis unit to analyze the at least one sensed motion of the user based on the object information; and a control unit to control the object displayed on the display unit based on an analysis result of the analysis unit, wherein the display device discontinues displaying the object when the object information is transmitted.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 illustrates an input system according to exemplary embodiments;

FIG. 2 illustrates a configuration of an input device according to exemplary embodiments;

FIG. 3 illustrates a flowchart of an operation of an input device and a display device according to exemplary embodiments;

FIG. 4 illustrates a configuration of a display device according to exemplary embodiments;

FIG. 5 illustrates a flowchart of an operation of a display device and an input device according to exemplary embodiments;

FIG. 6 illustrates a configuration of an input device according to other exemplary embodiments; and

FIG. 7 illustrates a flowchart of an operation of a display device and an input device according to other exemplary embodiments.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present disclosure by referring to the figures.

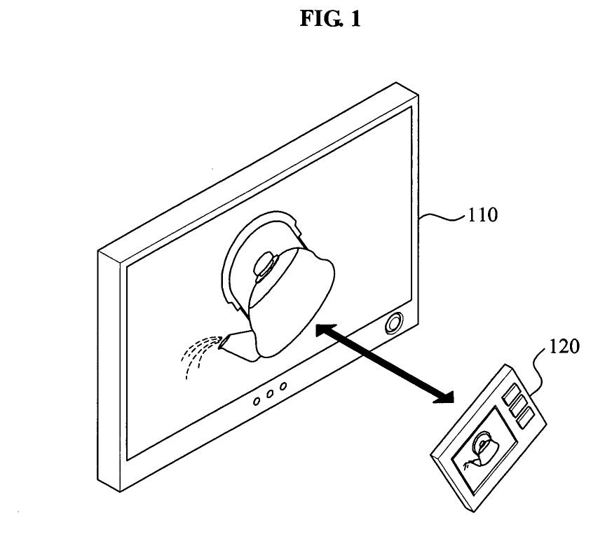

FIG. 1 illustrates an input system according to exemplary embodiments.

FIG. 1 illustrates a display device 110 and an input device 120.

According to exemplary embodiments, the display device 110 may be a microprocessor-based device displaying a predetermined object, for example, a laptop computer, a personal computer, a digital television (TV), a tabletop display, and the like.

When a user desires to control an object displayed on the display device 110 using the input device 120, the display device 110 may transmit object information to the input device 120.

When the input device 120 receives the object information from the display device 110, the input device 120 may sense at least one motion of a user, and enable a motion of the object, displayed on the display device 110, to be synchronized with the sensed at least one motion of the user.

That is, the user may control the motion of the object displayed on the display device 110 by making a particular motion using the input device 120.

For example, when a teakettle is displayed on the display device 110 as illustrated in FIG. 1, the user may control the teakettle displayed on the display device 110 to be tilted by tilting the input device 120.

An operation of the input device 120 is described in greater detail below.

The input device 120 may receive the object information from the display device 110, and sense the at least one motion of the user.

Also, the input device 120 may analyze the at least one sensed motion of the user based on the object information, and transmit a result of the analysis to the display device 110.

In this example, the display device 110 may receive the analysis result from the input device 120, and control the object displayed on the display device 110 based on the analysis result.

Referring to FIG. 1, when the user tilts the input device 120, the input device 120 may sense and analyze a motion of the user, and transmit a result of the analysis to the display device 110. Also, the display device 110 may control the teakettle displayed on the display device 110 to be tilted based on the analysis result, and enable water in the teakettle to be poured out.

According to exemplary embodiments, when the input device 120 senses a first predetermined motion of a user, the input device 120 may request the display device 110 for a transmission of the object information.

In this example, the display device 110 may transmit the object information to the input device 120, when the request for the transmission of the object information is received from the input device 120.

For example, when it is assumed that the first predetermined motion of the user is tilting the input device 120 to right, and the user tilts the input device 120 to right, the input device 120 may sense the first predetermined motion and request the display device 110 for the transmission of object information.

In this example, the display device 110 may transmit the object information to the input device 120, when the request for the transmission of the object information is received.

However, the first predetermined motion of the user may not be limited to the above-described exemplary embodiment. That is, the first predetermined motion of the user may include tilting the input device 120 to right, and shaking the input device 120. Also, when the display device 110 is a tabletop display, the first predetermined motion may be a motion of the user pressing the input device 120 located on the display device 110.

Also, the input device 120 may include a variety of sensing modules such as an acceleration sensor, an angular velocity sensor, a geomagnetic sensor, a gravity sensor, a pressure sensor, a touch sensor, and the like. Accordingly, the first predetermined motion of the user may vary depending on the sensing modules included in the input device 120.

That is, the input device 120 may receive the object information from the display device 110, only after the user makes the first predetermined motion. Accordingly, the input device 120 may control the object displayed on the display device 110.

According to other exemplary embodiments, however, the display device 110 may continuously transmit the object information to the input device 120.

In this example, after the first predetermined motion of the user is sensed, the input device 120 may receive the object information from the display device 110.

Specifically, although the display device 110 continuously transmits the object information to the input device 120, the input device 120 may receive the object information, only after the first predetermined motion of the user is sensed. Accordingly, the input device 120 may control the object displayed on the display device 110.

According to still other exemplary embodiments, a sensing module that senses a third predetermined motion of the user may be included in the display device 110. When the third predetermined motion of the user is sensed through the sensing module, the display device 110 may transmit the object information to the input device 120.

That is, according to still other exemplary embodiments, the display device 110 may sense the third predetermined motion of the user through the sensing module and transmit the object information to the input device 120, which is different from the above-described exemplary embodiments where the input device 120 determines whether to receive the object information.

According to exemplary embodiments, the input device 120 may further include a display unit. The display unit may analyze the object information received from the display device 110 and display the object.

According to exemplary embodiments, the input device 120 may control the object displayed on the display unit based on the analysis result obtained by sensing and analyzing the motion of the user, which is described in greater detail below.

The input device 120 may display an object identical to the object displayed on the display device 110 as illustrated in FIG. 1.

The teakettle is displayed on the display device 110 in FIG. 1, and thus the input device 120 may receive and analyze object information from the display device 110 and display the teakettle.

When the user tilts the input device 120, the input device 120 may sense and analyze the motion of the user, and control the teakettle displayed on the input device 120 to be tilted.

Specifically, when the user tilts the input device 120, the teakettle displayed on the display device 110 and the teakettle displayed on the input device 120 may be simultaneously tilted.

According to exemplary embodiments, the display unit may be arranged at each side of the input device 120 Also, the input device 120 may display a predetermined image associated with (corresponding to) the object depending on an arrangement state of the display unit.

For example, when the input device 120 is a hexahedron, the display unit may be arranged on each side of the input device 120.

In this example, the input device 120 may analyze the object information received from the display device 110, and display the object viewed from each side of the input device 120 through the display unit.

When the object is a teakettle, a top view of the teakettle may be displayed on a top side of the input device 120, and a right-side view of the teakettle may be displayed on a right side of the input device 120.

According to exemplary embodiments, the input device 120 may store the object information received from the display device 110.

Specifically, when the object information is received from the display device 110, the input device 120 may store the object information and analyze the at least one motion of the user based on the stored object information.

According to exemplary embodiments, when the input device 120 senses a second predetermined motion of the user, the input device 120 may delete the stored object information.

That is, the input device 120 may delete the stored object information when the second predetermined motion of the user is sensed, and thereby may discontinue controlling the object displayed on the display device 110.

According to other exemplary embodiments, however, when the input device 120 senses the second predetermined motion of the user, the input device 120 may discontinue sensing the at least one motion of the user.

Specifically, when the second predetermined motion of the user is sensed, the input device 120 may discontinue sensing the at least one motion of the user regardless of whether the object information is stored. Accordingly, the input device 120 may discontinue controlling the object displayed on the display device 110.

The operations of the input device 120 and the display device 110 have been described in detail above. However, the input device 120 and the display device 110 may not be limited to the above-described embodiments where the input device 120 may sense the at least one motion of the user and transmit the analysis result to the display device 110.

Hereinafter, according to yet other exemplary embodiments, it is described that the display device 110 may sense and analyze a motion of a user and control an object.

When the user makes at least one motion using the input device 120, the display device 110 may sense the at least one motion of the user.

Also, the display device 110 may analyze the at least one sensed motion of the user based on object information associated with (corresponding to) the object displayed on the display device 110.

The display device 110 may control the object based on a result of the analysis.

For example, when the teakettle is displayed on the display device 110 as illustrated in FIG. 1, and the user makes a motion such as tilting the input device 120, the display device 110 may sense the motion of the user and analyze the motion of the user based on object information, and thereby may control the teakettle displayed on the display device 110 to be tilted.

Also, when the display device 110 determines that the teakettle is filled with water as a result of the analysis based on the object information, the display device 110 may enable the water in the teakettle to be poured out.

According to exemplary embodiments, the display device 110 may transmit the object information to the input device 120.

According to exemplary embodiments, the input device 120 may receive and analyze the object information, and display the object based on the analysis result of the object information.

In this example, when the display device 110 senses a first predetermined motion of the user, the display device 110 may transmit the object information to the input device 120.

That is, when the user makes the first predetermined motion, the display device 110 may sense the first predetermined motion of the user and transmit the object information to the input device 120.

Also, according to exemplary embodiments, when a second predetermined motion of the user is sensed, the display device 110 may discontinue sensing the at least one motion of the user, and transmit discontinuation information to the input device 120. The discontinuation information may be associated with the discontinuation of the sensing of the at least one motion of the user.

According to exemplary embodiments, when the input device 120 receives the discontinuation information from the display device 110, the input device 120 may discontinue displaying the object.

That is, when the user makes the second predetermined motion, a predetermined operation associated with the object control between the display device 110 and the input device 120 may be discontinued.

Also, according to exemplary embodiments, the input device 120 may sense the at least one motion of the user through a sensing module, analyze the at least one sensed motion of the user based on the object information, and control the object displayed on the input device 120.

That is, the sensing module is included in the input device 120, a motion of the object displayed on the display device 110 and a motion of the object displayed on the input device 120 may be simultaneously controlled when the user makes a predetermined motion.

For example, when the user tilts the input device 120 to the left, the displayed on the input device 120 may be tilted to the left.

According to exemplary embodiments, when the input device 120 senses a third predetermined motion of the user through the sensing module and requests a transmission of the object information, the display device 110 may transmit the object information to the input device 120.

That is, the display device 110 may transmit the object information to the input device 120, when the transmission of the object information is requested from the input device 120.

The operation of controlling the object displayed on the display device 110 through the input device 120 has been described in detail above. However, according to further embodiments, the input device 120 may receive object information, associated with an object, from the display device 110 and display the object. In this example, the display device 110 may discontinue displaying the object. That is, the object displayed on the display device 110 may move to the input device 120, which is described in detail.

The input device 120 may receive the object information associated with the object displayed on the display device 110, from the display device 110.

Also, the input device 120 may analyze the object information and display the object.

In this example, the display device 110 may discontinue displaying the object.

Then, the input device 120 may sense at least one motion of the user.

Also, the input device 120 may analyze the at least one sensed motion of the user based on the object information, and control the object displayed on the input device 120 based on the analysis result.

Accordingly, the user may control the object displayed on the input device 120 through the at least one motion of the user by moving the object displayed on the display device 110 from the display device 110 to the input device 120.

According to exemplary embodiments, when the input device 120 senses a first predetermined motion of the user, the input device 120 may request the display device 110 for a transmission of the object information.

According to exemplary embodiments, when the request for the transmission of the object information is received from the input device 120, the display device 110 may transmit the object information to the input device 120.

According to other exemplary embodiments, however, the display device 110 may continuously transmit the object information to the input device 120.

However, only when the first predetermined motion of the user is sensed, the input device 120 may receive the object information from the display device 110.

Specifically, although the display device 110 continuously transmits the object information to the input device 120, the input device 120 may receive the object information, only after the first predetermined motion of the user is sensed.

According to still other exemplary embodiments, the sensing module that senses a third predetermined motion of a user may be included in the display device 110.

When the third predetermined motion of the user is sensed through the sensing module, the display device 110 may transmit the object information to the input device 120.

That is, according to still other exemplary embodiments, the display device 110 may sense the third predetermined motion of the user through the sensing module and transmit the object information to the input device 120, which is different from the above-described exemplary embodiments where the input device 120 determines whether to receive the object information.

According to exemplary embodiments, the input device 120 may store the object information received from the display device 110.

Specifically, when the object information is received from the display device 110, the input device 120 may store the object information and analyze the at least one motion of the user based on the stored object information.

According to exemplary embodiments, when the input device 120 senses a second predetermined motion of the user, the input device 120 may delete the stored object information.

That is, the input device 120 may delete the stored object information when the second predetermined motion of the user is sensed, and thereby may discontinue controlling the object displayed on the input device 110.

The exemplary embodiments where the object is moved from the display device 110 to the input device 120 have been described. Although the exemplary embodiment where the input device 120 controls the object displayed on the display device 110 and the exemplary embodiment where the object moves from the display device 110 to the input device 120 have been separately described in the present specification, the above-described two exemplary embodiments may be performed in the single input device 120.

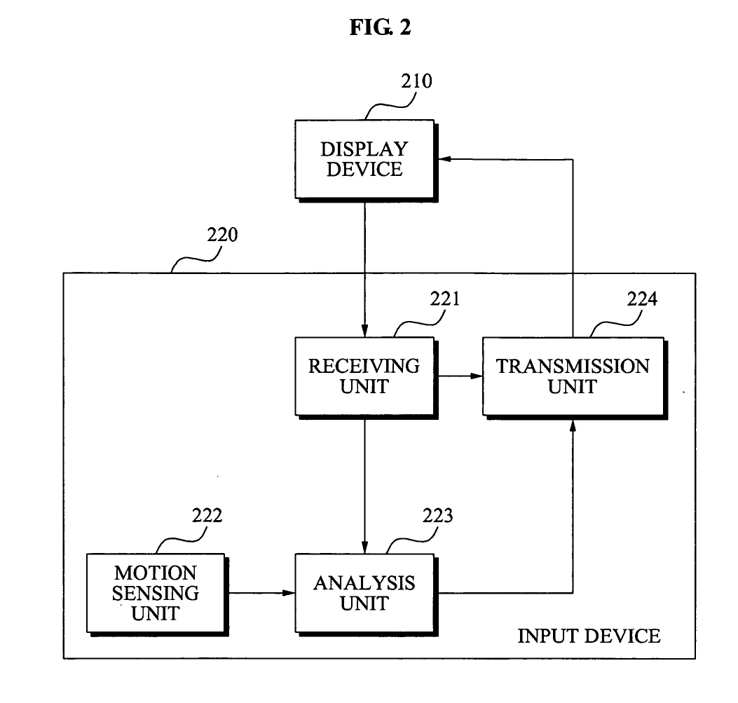

FIG. 2 illustrates a configuration of an input device 220 according to exemplary embodiments.

FIG. 2 illustrates a display device 210 and the input device 220.

The input device 220 may include a receiving unit 221, a motion sensing unit 222, an analysis unit 223, and a transmission unit 224.

The receiving unit 221 may receive object information from the display device 210. The object information may be associated with an object displayed on the display device 210.

The motion sensing unit 222 may sense at least one motion of a user.

According to exemplary embodiments, the input device 220 may further include a request unit (not shown).

The request unit may request the display device 210 for a transmission of the object information, when the motion sensing unit 222 senses a first predetermined motion of the user.

In this example, when the request for the transmission of the object information is received from the input device 220, the display device 210 may transmit the object information to the input device 220.

According to other exemplary embodiments, the display device 210 may continuously transmit the object information to the input device 220.

In this example, when the motion sensing unit 222 senses the first predetermined motion of the user, the receiving unit 221 may receive the object information from the display device 210.

According to still other exemplary embodiments, the display device 210 may sense a third predetermined motion of the user through a sensing module (not shown). When the sensing module senses the third predetermined motion of the user, the display device 210 may transmit the object information to the input device 220.

The analysis unit 223 may analyze the at least one sensed motion of the user based on the object information.

The transmission unit 224 may transmit the analysis result of the analysis unit 223 to the display device 210.

The display device 210 may receive the analysis result and control the object displayed on the display device 210 based on the analysis result.

According to exemplary embodiments, the input device 220 may further include a display unit (not shown).

The display unit may analyze the object information and display the object.

According to exemplary embodiments, the input device 220 may further include a control unit (not shown).

The control unit may control the object displayed on the display unit based on the analysis result of the analysis unit 223.

According to exemplary embodiments, the input device 220 may further include a storage unit (not shown) and a deletion unit (not shown).

The storage unit may store the object information.

According to exemplary embodiments, the analysis unit 223 may analyze the at least one sensed motion of the user based on the object information stored in the storage unit.

The deletion unit may delete the object information stored in the storage unit, when the motion sensing unit 222 senses a second predetermined motion of the user.

According to other exemplary embodiments, when the second predetermined motion of the user is sensed, the motion sensing unit 222 may discontinue sensing the at least one motion of the user.

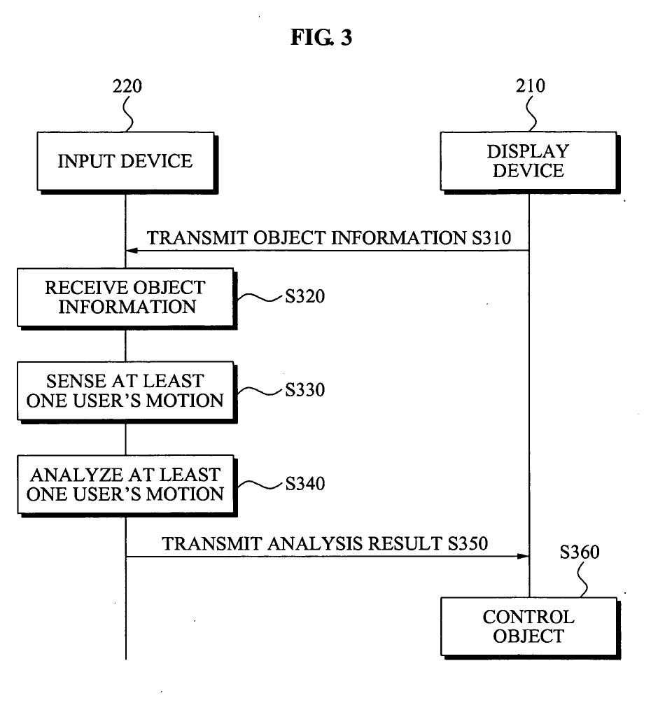

Hereinafter, an operation of the display device 210 and an operation of the input device 220 are described in detail with reference to FIG. 3.

FIG. 3 illustrates a flowchart of an operation of the input device 220 and the display device 210 according to exemplary embodiments.

The input device 220 and the display device 210 are illustrated in FIG. 3.

In operation S310, the display device 210 may transmit the object information to the input device 220. The object information may be associated with the object displayed on the display device 210.

According to exemplary embodiments, when the input device 220 senses the first predetermined motion of the user prior to operation S310, the input device 220 may request the display device 210 for a transmission of the object information.

According to exemplary embodiments, when the request for the transmission of the object information is received from the input device 220, the display device 210 may transmit the object information to the input device 220 in operation S310.

According to other exemplary embodiments, the display device 210 may sense the third predetermined motion of the user through the sensing module.

According to exemplary embodiments, when the sensing module senses the third predetermined motion of the user, the display device 210 may transmit the object information to the input device 220 in operation S310.

In operation S320, the input device 220 may receive the object information transmitted in operation S310.

According to still other exemplary embodiments, the display device 210 may continuously transmit the object information to the input device 220 in operation S310.

According to exemplary embodiments, when the input device 220 senses the first predetermined motion of the user, the input device 220 may receive the object information from the display device 210 in operation S320.

In operation S330, the input device 220 may sense the at least one motion of the user.

According to exemplary embodiments, when the input device 220 senses the second predetermined motion of the user, the input device 220 may discontinue sensing the at least one motion of the user in operation S330.

In operation S340, the input device 220 may analyze the at least one motion of the user, sensed in operation S330, based on the object information received in operation S320.

According to exemplary embodiments, the input device 220 may store the object information in the input device 220 prior to operation S330.

According to exemplary embodiments, the input device 220 may analyze the at least one sensed motion of the user based on the stored object information in operation S340.

According to exemplary embodiments, when the input device 220 senses the second predetermined motion of the user in operation S330, the input device 220 may delete the object information stored in the input device 220.

In operation S350, the input device 220 may transmit the analysis result, obtained in operation S340, to the display device 210.

In operation S360, the display device 210 may receive the analysis result, transmitted in operation S350, and control the object based on the analysis result.

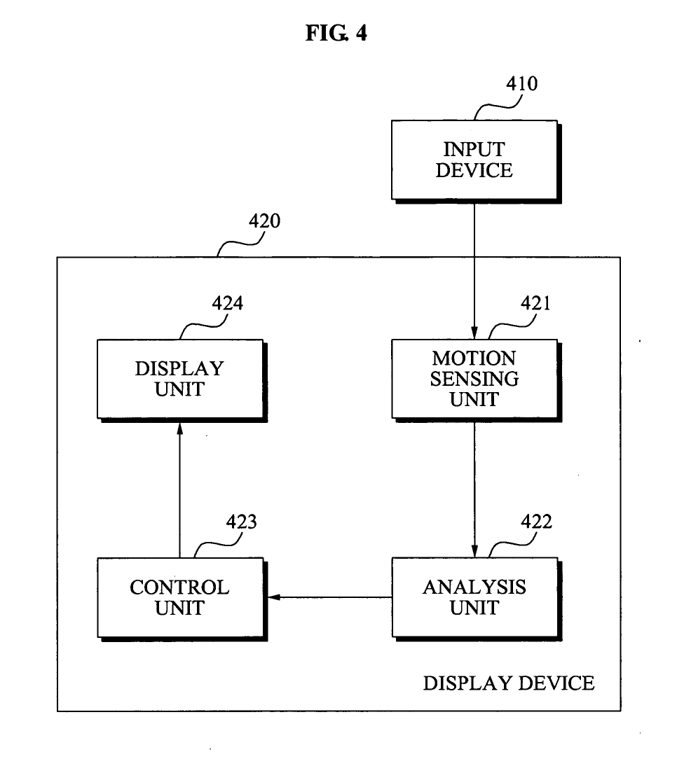

FIG. 4 illustrates a configuration of a display device 420 according to exemplary embodiments.

An input device 410 and the display device 420 are illustrated in FIG. 4.

The display device 420 may include a motion sensing unit 421, an analysis unit 422, a control unit 423, and a display unit 424.

The display unit 424 may display a predetermined object.

The motion sensing unit 421 may sense at least one motion of a user through the input device 410.

For example, when the user shakes the input device 410 left and right, the motion sensing unit 421 may sense the motion of the user.

The analysis unit 422 may analyze the at least one motion of the user, sensed through the motion sensing unit 421, based on object information. The object information may be associated with the object.

The control unit 423 may control the object, displayed on the display unit 424, based on the analysis result of the analysis unit 422.

According to exemplary embodiments, the display device 420 may further include a transmission unit (not shown). The transmission unit may transmit the object information to the input device 410.

According to exemplary embodiments, the input device 410 may receive the object information from the display device 420 and analyze the object information. Also, the input device 410 may display the object based on an analysis result of the object information.

According to exemplary embodiments, when the motion sensing unit 421 senses a first predetermined motion of the user, the transmission unit may transmit the object information to the input device 410.

According to exemplary embodiments, when the motion sensing unit 421 senses a second predetermined motion of the user, the motion sensing unit 421 may discontinue sensing the at least one motion of the user.

According to exemplary embodiments, the transmission unit may transmit discontinuation information to the input device 410. The discontinuation information may be associated with the discontinuation of the sensing of the at least one motion of the user.

According to exemplary embodiments, when the discontinuation information is received from the display device 420, the input device 410 may discontinue displaying the object.

According to exemplary embodiments, the input device 410 may sense the at least one motion of the user through a sensing module.

According to exemplary embodiments, the input device 410 may analyze the at least one sensed motion of the user based on the object information, received from the display device 420, and may control the object displayed on the input device 410.

According to exemplary embodiments, when the input device 410 senses a third predetermined motion of the user through the sensing module and requests a transmission of the object information, the transmission unit may transmit the object information to the input device 410.

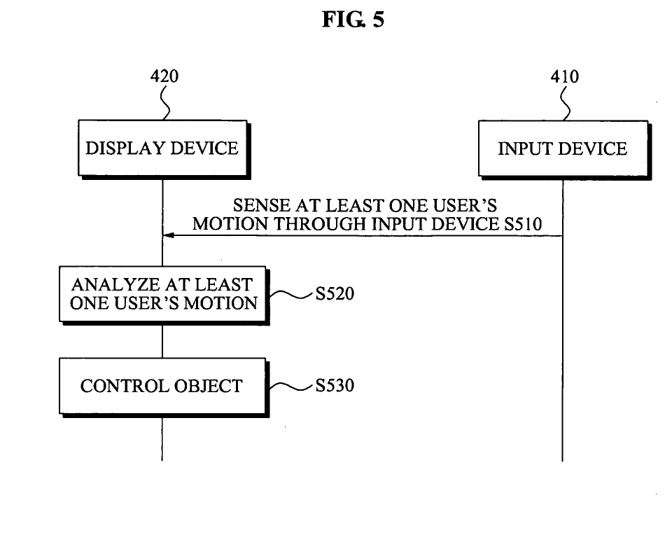

Hereinafter, an operation of the input device 410 and an operation of the display device 420 are described in detail with reference to FIG. 5.

FIG. 5 illustrates a flowchart of an operation of the display device 420 and the input device 410 according to exemplary embodiments.

The display device 420 and the input device 410 are illustrated in FIG. 5.

In operation S510, the display device 420 may sense at least one motion of a user through the input device 410.

In operation S520, the display device 420 may analyze the at least one motion of the user, sensed in operation S510, based on the object information. The object information may be associated with the object displayed on the display device 420.

According to exemplary embodiments, the display device 420 may transmit the object information to the input device 410 prior to operation S520.

According to exemplary embodiments, the input device 410 may receive and analyze the object information, and display the object based on the analysis result of the object information.

Also, according to exemplary embodiments, when the display device 420 senses the first predetermined motion of the user in operation S510, the display device 420 may transmit the object information to the input device 410.

Also, according to exemplary embodiments, when the display device 420 senses the second predetermined motion of the user in operation S510, the display device 420 may discontinue sensing the at least one motion of the user.

According to exemplary embodiments, the display device 420 may transmit the discontinuation information to the input device 410. The discontinuation information may be associated with the discontinuation of the sensing of the at least one motion of the user.

According to exemplary embodiments, when the input device 410 receives the discontinuation information from the display device 420, the input device 410 may discontinue displaying the object.

According to exemplary embodiments, the input device 410 may sense the at least one motion of the user through the sensing module.

According to exemplary embodiments, the input device 410 may analyze the at least one sensed motion of the user based on the object information, received from the display device 420, and control the object displayed on the input device 410.

According to exemplary embodiments, when the input device 410 senses the third predetermined motion of the user through the sensing module and requests a transmission of the object information, the display device 420 may transmit the object information to the input device 410.

In operation S530, the display device 420 may control the object displayed on the display device 420 based on the analysis result obtained in operation S520.

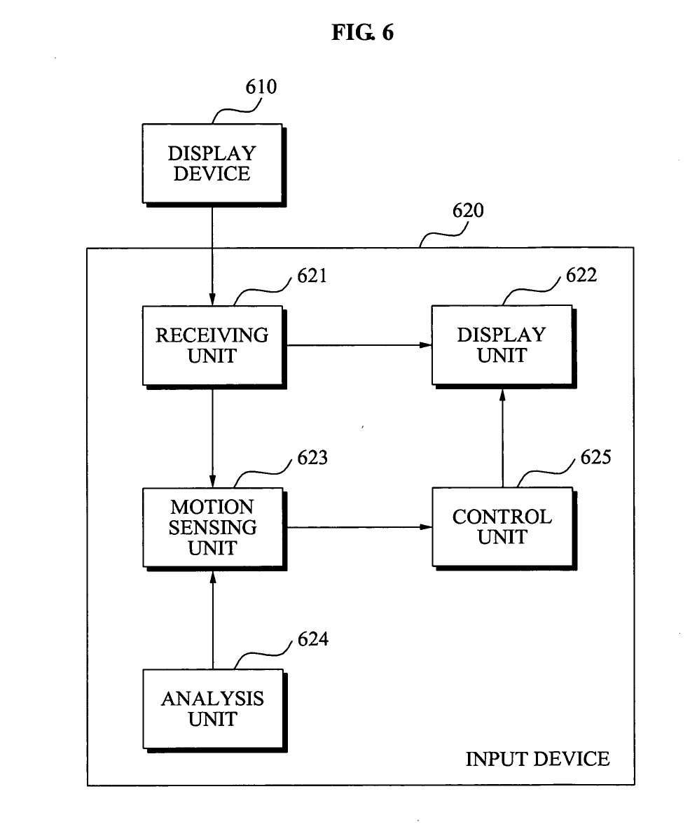

FIG. 6 illustrates a configuration of an input device 620 according to other exemplary embodiments.

A display device 610 and the input device 620 are illustrated in FIG. 6.

The input device 620 may include a receiving unit 621, a display unit 622, a motion sensing unit 623, an analysis unit 624, and a control unit 625.

The receiving unit 621 may receive object information from the display device 610. The object information may be associated with an object displayed on the display device 610.

In this example, the display device 610 may discontinue displaying the object.

According to exemplary embodiments, the display device 610 may sense a third predetermined motion of the user through a sensing module.

According to exemplary embodiments, when the sensing module senses the third predetermined motion of the user, the display device 610 may transmit the object information to the input device 620.

The display unit 622 may analyze the object information and display the object.

The motion sensing unit 623 may sense at least one motion of the user.

According to exemplary embodiments, the input device 620 may further include a request unit (not shown).

The request unit may request the display device 610 for a transmission of the object information when the motion sensing unit 623 senses a first predetermined motion of the user.

According to exemplary embodiments, when the request for the transmission of the object information is received from the input device 620, the display device 610 may transmit the object information to the input device 620.

According to other exemplary embodiments, the display device 610 may continuously transmit the object information to the input device 620.

According to exemplary embodiments, when the motion sensing unit 623 senses the first predetermined motion of the user, the receiving unit 621 may receive the object information from the display device 610.

The analysis unit 624 may analyze the at least one motion of the user, sensed by the motion sensing unit 623, based on the object information received by the receiving unit 621.

According to exemplary embodiments, the input device 620 may further include a storage unit (not shown). The storage unit may store the object information received by the receiving unit 621.

According to exemplary embodiments, the analysis unit 624 may analyze the at least one motion of the user based on the object information stored in the storage unit.

Also, according to exemplary embodiments, the input device 620 may further include a deletion unit (not shown). The deletion unit may delete the object information stored in the storage unit, when the motion sensing unit 623 senses a second predetermined motion of the user.

According to exemplary embodiments, the input device 220 illustrated in FIG. 2 and the input device 620 illustrated in FIG. 6 may be embodied as a single input device.

That is, the single input device may perform both operation of the input device 220 illustrated in FIG. 2 and operation of the input device 620 illustrated in FIG. 6 depending on a selection of the user.

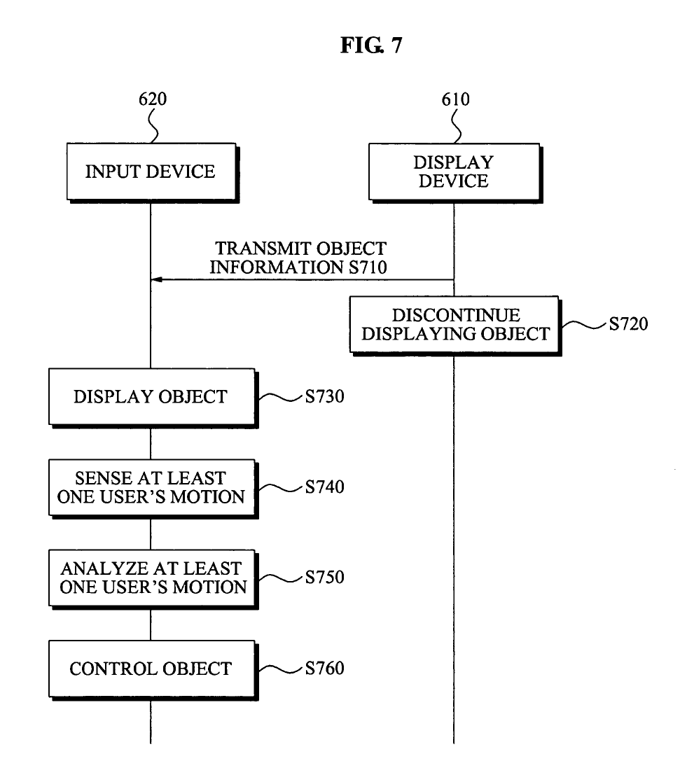

Hereinafter, an operation of the display device 610 and an operation of the input device 620 are described in detail with reference to FIG. 7.

FIG. 7 illustrates a flowchart of an operation of the display device 610 and the input device 620 according to other exemplary embodiments.

The display device 610 and the input device 620 are illustrated in FIG. 7.

In operation S710, the display device 610 may transmit the object information to the input device 620. The object information may be associated with the object displayed on the display device 610.

According to exemplary embodiments, when the input device 620 senses the first predetermined motion of the user prior to operation S710, the input device 620 may request the display device 610 for a transmission of the object information.

According to exemplary embodiments, when the request for the transmission of the object information is received from the input device 620, the display device 610 may transmit the object information to the input device 620 in operation S710.

According to other exemplary embodiments, the display device 610 may sense a third predetermined motion of a user through the sensing module.

According to exemplary embodiments, when the sensing module senses the third predetermined motion of the user, the display device 610 may transmit the object information to the input device 620 in operation S710.

According to still other exemplary embodiments, the display device 610 may continuously transmit the object information to the input device 620 in operation S710.

According to exemplary embodiments, when the input device 620 senses the first predetermined motion of the user, the input device 620 may receive the object information from the display device 610.

In operation S720, the display device 610 may discontinue displaying the object.

In operation S730, the input device 620 may analyze the object information transmitted in operation S710, and display the object.

In operation S740, the input device 620 may sense the at least one motion of the user.

According to exemplary embodiments, when the input device 620 senses the second predetermined motion of the user, the input device 620 may discontinue sensing the at least one motion of the user in operation S740.

In operation S750, the input device 620 may analyze the at least one motion of the user, sensed in operation S740, based on the object information received in operation S710.

According to exemplary embodiments, the input device 620 may store the object information in the input device 620 prior to operation S730.

According to exemplary embodiments, the input device 620 may analyze the at least one sensed motion of the user based on the stored object information in operation S750.

Also, according to exemplary embodiments, when the input device 620 senses the second predetermined motion of the user in operation S740, the input device 620 may delete the object information stored in the input device 620.

In operation S760, the input device 620 may control the object, displayed in operation S730, based on the analysis result obtained in operation S750.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. An input device, comprising:
a receiving unit to receive object information from a display device, the object information being associated with an object displayed on the display device;
a motion sensing unit to sense at least one motion of a user;
an analysis unit to analyze the at least one sensed motion of the user based on the object information; and
a transmission unit to transmit the analysis result of the analysis unit to the display device,
wherein the display device receives the analysis result and controls the object based on the analysis result.

2. The input device of claim 1, further comprising:
a display unit to analyze the object information and display the object.

3. The input device of claim 2, further comprising:
a control unit to control the object displayed on the display unit based on the analysis result of the analysis unit.

4. The input device of claim 1, further comprising:
a request unit to request the display device to transmit the object information when the motion sensing unit senses a first predetermined motion of the user,
wherein the display device transmits the object information to the input device, when the request is received by the display device.

5. The input device of claim 1, wherein the receiving unit receives the object information from the display device, when the motion sensing unit senses a first predetermined motion of the user.

6. The device of claim 1, further comprising:
a storage unit to store the object information; and
a deletion unit to delete the object information stored in the storage unit, when the motion sensing unit senses a second predetermined motion of the user.

7. The input device of claim 1, wherein the motion sensing unit discontinues the sensing of the at least one motion of a user, when a second predetermined motion of the user is sensed.

8. The input device of claim 1, wherein the display device senses another predetermined motion of the user through a sensing module, and when the sensing module senses the third predetermined motion of the user, the display device transmits the object information to the input device.

9. A display device, comprising:
a display unit to display an object;
a motion sensing unit to sense at least one motion of a user through an input device;
an analysis unit to analyze the at least one sensed motion of the user based on object information associated with the object; and
a control unit to control the object based on the analysis result of the analysis unit.

10. The display device of claim 9, further comprising:
a transmission unit to transmit the object information to the input device, wherein the input device receives and analyzes the object information, and displays the object based on an analysis result of the object information.

11. The display device of claim 10, wherein the transmission unit transmits the object information to the input device when the motion sensing unit senses a first predetermined motion of the user.

12. The display device of claim 10, wherein the motion sensing unit discontinues sensing the at least one motion of the user when a second predetermined motion of the user is sensed, the transmission unit transmits discontinuation information to the input device, and the input device discontinues the displaying of the object when the discontinuation information is received, the discontinuation information being associated with the discontinuation of the sensing of the at least one motion of the user.

13. The display device of claim 10, wherein the input device senses the at least one motion of the user through a sensing module, analyzes the at least one sensed motion of the user based on the object information, and controls the object displayed on the input device.

14. The display device of claim 13, wherein the transmission unit transmits the object information to the input device, when the input device senses another predetermined motion of the user through the sensing module and requests a transmission of the object information.

15. An input device, comprising:
a receiving unit to receive object information from a display device, the object information being associated with an object displayed on the display device;
a display unit to analyze the object information and display the object;
a motion sensing unit to sense at least one motion of a user;
an analysis unit to analyze the at least one sensed motion of the user based on the object information; and
a control unit to control the object displayed on the display unit based on the analysis result of the analysis unit,
wherein the display device discontinues displaying the object when the object information is transmitted.

16. The input device of claim 15, further comprising:
a request unit to request the display device to transmit the object information when the motion sensing unit senses a first predetermined motion of the user,
wherein the display device transmits the object information to the input device, when the request is received by the display device.

17. The input device of claim 15, wherein the receiving unit receives the object information from the display device, when the motion sensing unit senses a first predetermined motion of the user.

18. The input device of claim 15, further comprising:
a storage unit to store the object information; and
a deletion unit to delete the object information stored in the storage unit, when the motion sensing unit senses a second predetermined motion of the user.

19. The input device of claim 15, wherein the display device senses another predetermined motion of the user through a sensing module, and when the sensing module senses the third predetermined motion of the user, the display device transmits the object information to the input device.
